(19) United States
(12) Patent Application Publication
(10) Pub. No.: US 2026/0104345 A1
(43) Pub. Date: Apr. 16, 2026

(54) Climate Chamber

(71) Applicant: Binder GmbH, Tuttlingen (DE)

(72) Inventors: Ahmet ARABUL, Tuttlingen (DE); Jochen BUSCHLE, Tuttlingen (DE); Patrick EFINGER, Aldingen (DE); Ante URTIC, Mönchweiler (DE)

(73) Assignee: Binder GmbH, Tuttlingen (DE)

(21) Appl. No.: 19/338,758

(22) Filed: Sep. 24, 2025

(30) Foreign Application Priority Data
Oct. 14, 2024 (DE) 1020241296917

(51) Int. Cl. G01N 17/00

(52) U.S. Cl. CPC G01N 17/002

(57) ABSTRACT

A climate chamber comprising a double wing door movable between an open and a closed position. The double wing door comprises a first door and a second door, wherein the first door comprises a first front side with a first ledge and the second door comprises a second front side with a second ledge. The first front side and the second front side are substantially facing each other in the closed position. A heating element is disposed within the first ledge of the first door to prevent icing and condensation in the proximity of the ledges, thereby improving sealing performance and maintaining sample integrity during testing.

### CROSS REFERENCE TO RELATED APPLICATIONS

This application claims the benefit of priority under 35 U.S.C. §119(a) to German Patent Application No. 10 2024 129 691.7, filed Oct. 14, 2024, which is hereby incorporated by reference in its entirety.

### FIELD OF DISCLOSURE

The application relates to a climate chamber.

### BACKGROUND

Climate chambers in various physical forms are known in prior art and are employed in scientific laboratories or industrial operations for the purpose of simulating biological, chemical and/or physical environmental conditions, such as for example temperature, atmospheric pressure and/or humidity. A climate chamber comprises a housing with an interior volume within the housing, wherein in the interior volume the biological, chemical and/or physical environmental conditions are simulated.

Furthermore, climate chambers are known whose interior volume is closable via a double wing door, in particular via a specific double wing door. Double wing doors comprise a first and a second door which are each preferably rotatably supported on the housing of the climate chamber. Double wing doors have the advantage that the first and the second door can be opened independently of one another, for example in order to be able to access independently of one another the individual segments of a segmented interior volume from the outside. In addition, opening a two wing door requires less space since the rotational movement involving two doors is less than it is in the case of one door, which is of advantage in tightly narrow laboratory facilities.

Climate chambers can typically set temperatures between −10° C. and 100° C. However, there are likewise climate chambers for high-temperature ranges which can set temperatures within the interior volume of up to 350° C. over long periods of time or also low-temperature devices which can set temperatures down to −85° C. over long periods of time. Therefore, the first and the second door of the double wing door must be developed to be as tight as possible in the closed state and with respect to one another. The first and the second door frequently comprise a rabbet complementary to one another, each of which is formed by a first and a second ledge in order to improve the sealing performance.

Of disadvantage in such a climate chamber is that in the proximity of the ledge icing or condensation occurs to an increased degree which can have negative effects on the sealing performance of the double wing door. Moreover, icing and/or condensation in the proximity of the first and the second ledge can lead to falsification of the sample integrity and therewith to that of the test results.

The application therefore addresses the problem of avoiding icing and/or condensation in the proximity of the ledge.

### SUMMARY

This problem is resolved through a climate chamber with the characteristics disclosed herein.

Therefore according to an embodiment in a climate chamber with a double wing door movable between an open and a closed position, wherein the double wing door comprises a first door and a second door, wherein the first door comprises a first front face with a first ledge and the second door comprises a second front face with a second ledge, wherein the first front face and the second front face essentially are facing each other in the closed position, a heating element is disposed within the first ledge of the first door. It is herein advantageous that condensation at high temperatures and icing at low temperatures in the proximity of the first and second ledge can be prevented. The heating element, in addition, is disposed within the first ledge and consequently is not accessible from the outside, which entails the advantage that higher voltages, for example 230 V, can be employed.

The first ledge and the second ledge preferably form at least partially a door rabbet, wherein the first and second ledge and their door rabbet, respectively, is developed or disposed such that in the closed position they at least partially complementarily engage one into the other. Thereby between the first ledge and the second ledge a gap is preferably developed. The first and the second ledge can also be developed and disposed such that the first ledge is disposed on the second ledge under form closure and that therewith no gap is formed between the first and the second door. Due to the development of a first and a second ledge the impermeability of the double wing door is increased.

According to an embodiment the first ledge extends substantially over the entire length of the first front face and the second ledge extends substantially over the entire length of the second front face. This has the advantage that thereby over the entire length of the first and second front face an increased sealing performance of the double wing door can be achieved.

According to an further development the heating element extends substantially over the entire length of the first ledge. The first ledge is thereby heated over its entire length such that no condensation or icing can form over the entire first ledge. In addition, the heating element radiates its heat starting from the first ledge in the direction of the second ledge such that condensation and icing can also be prevented in the proximity of the second ledge through the heating element disposed within the first ledge.

The double wing door preferably comprises a front face and a back face, wherein the first ledge in the direction of a longitudinal axis which orthogonally intersects the front face and preferably the back face and, starting from the front face, extends in the direction of the back face, is at least partially disposed behind the second ledge. Through this disposition the heating element which is disposed within the first ledge acts thermally onto the second ledge and thereby prevents condensation and icing in the entire gap region. The disposition of a sealing element within the gap in such a disposition of the first and second ledge can moreover be simpler and more secure.

In conjunction the front face is defined as that side which is formed by the first and the second door which, in the closed position, spans a common plane facing toward the outer environment.

The back side is defined as that side which is formed by the first and the second door which, in the closed position, spans a common plane facing toward the interior volume of the housing of the climate chamber.

The heating element is, at least partially, preferably disposed behind the second ledge. The thermal coupling between the heating element disposed in the first ledge and the gap as well as with the second ledge, can thereby be improved.

According to an especially embodiment in the closed position a sealing element is disposed between the first ledge and the second ledge, in particular within the gap. The sealing element is preferably fabricated of an at least partially elastic material such that the sealing element can fit tightly between the first and/or the second ledge in order to seal the interior volume of the climate chamber against external effects.

According to a further development the heating element comprises a forward conductor and a return conductor wherein the forward conductor and the return conductor are substantially disposed within the first ledge. Thereby heat radiation over the entire width and length of the first ledge can be achieved such that the thermally critical region within the proximity of the first ledge can remain completely free of condensation and ice. In addition, a more compact system of the climate chamber can be achieved when the forward conductor and the return conductor are led substantially parallel to one another.

The forward conductor and the return conductor are preferably connected in series and electrically connected with one another. The forward conductor and the return conductor can also be interconnected in parallel. The forward conductor and the return conductor are preferably electrically connected to the same energy source.

In at least one corner region of the first door the heating element preferably has a loop-shaped course. In the corner regions of the first door heightened condensation and icing occur. A loop-form course in at least one corner region can effect greater heat development in this region such that stronger condensation and icing can be counteracted in this region.

The heating element advantageously comprises an electrically conductive wire with a silicone sheathing. The electrically conductive wire is preferably developed of copper. The wire can also be developed of any other conductive material. The wire can be developed of a single strand or of many electrically interconnected single strands. The individual strands can herein be connected in series as well as also parallel. About the individual strands or each individual strand or the individual wire an insulation layer can be disposed.

Within the first ledge of the first door advantageously also two or more in particular independently actuatable heating elements can be disposed.

According to an embodiment, the heating element is electrically connected to a low voltage direct current source. The heating element can also be electrically connected to a high voltage direct current source or to an alternating voltage source, for example to the 230 V network customary in Europe. The advantage of a low voltage direct current is that in the event of failure even a layperson can carry out the exchange or repair of individual electrical components. The voltage range of the low voltage direct current source is preferably between 12 V and 60 V.

According to a further development, the first and the second door comprise an outer body with good thermal conductivity, preferably of stainless steel, wherein the outer body is injected with a thermally good insulating foam. It can be advantageous in an outer body with good thermal conductivity that the heat output by the heating element can be better radiated in the direction of the gap and of the second ledge. It can be advantageous in a thermally good insulating foam that thereby the first and the second door reduce an exchange of heat and/or cold to a minimum, in the best case prevent it entirely.

The heating element is preferably fixed by the foam within the first ledge. The heating element can thereby remain in its intended location within the first element even under mechanical stress exerted from the outside onto the climate chamber. The heating element is placed within the first ledge during the production process. The heating element is preferably fixed and clamped by the outer body inside the first ledge. The hollow volume defined by the outer body is subsequently injected with a foam, preferably a polyurethane foam. An ethylene propylene diene monomer foam, a silicone foam or a neoprene foam can also be utilized.

The heating element, in particular the silicone sheathing of the wire and accordingly the silicone sheathing of the individual strands of the wire, is at least on one side advantageously in contact with the outer body of the first door. The heating element can also be in contact with the outer body at two, three or more sites. The heating element is preferably fixed between two side faces of the outer body under clamping. By staying or contacting good thermal coupling between the heating element and the outer body is established whereby, in turn, the heat transfer into the surrounding, in particular into the region of the first and second ledge, can be improved.

According to a further development, area heating is thermally coupled with the first and/or the second door. Area heating can be employed in order to attain icing protection as well as condensation protection over the entire door area. The area heating is preferably disposed in loop form within the hollow volume, defined in particular by the outer body, and can be mechanically fixed by injecting the foam. The heating element and the area heating can be electrically connected with one another. The area heating and the heating element can be connected in series or parallel. The area heating can be electrically connected to a current source other than the heating element or the area heating can be electrically connected to the same current source as the heating element.

According to an embodiment a second heating element is disposed within the second ledge. Due to the limited space within the first ledge it may be advisable to dispose a second heating element within the second ledge. The second heating element can herein be developed identically to the heating element within the first ledge.

### BRIEF DESCRIPTION OF THE DRAWINGS

In the following Figures an embodiment will be explained in detail. Therein depict:

FIG. 1 a view from the front onto an embodiment example of a climate chamber with a double wing door, wherein a first door is disposed in a closed position and a second door in an opened position,

FIG. 2 a perspective view onto the climate chamber according to FIG. 1,

FIG. 3 a view from above onto the climate chamber according to FIG. 1 with a double wing door in a closed position,

FIG. 4 a detail enlargement of a cross section through the climate chamber according to FIG. 3 and

FIG. 5 a detail enlargement of a cross section through the climate chamber according to FIG. 3 with an emplaced sealing element, wherein, in spite of the closed door, the sealing element is depicted in the unstressed state.

### DETAILED DESCRIPTION

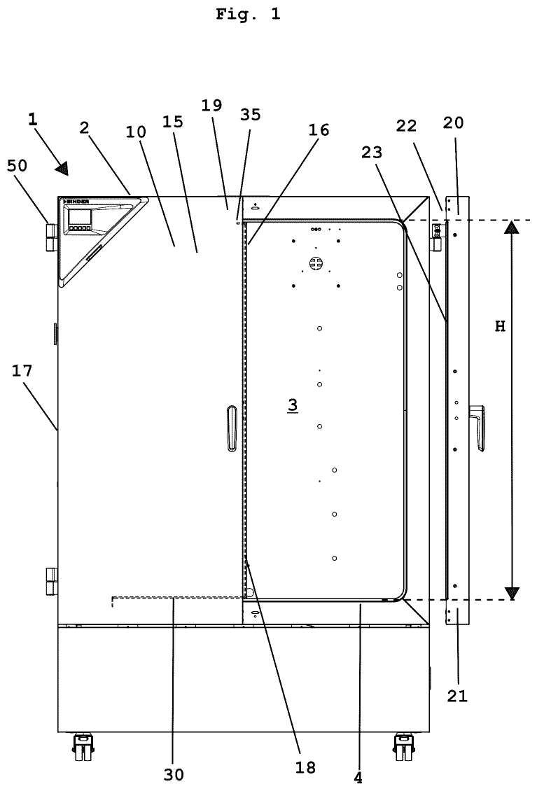

FIGS. 1 to 5 show different views of an embodiment example of a climate chamber 1 with a housing 2 and an interior volume 3 disposed within the housing 2 having a height H and a bottom 4.

The interior volume 3 of housing 2 is closable with a double wing door 10. The double wing door 10 comprises a first door 15 and a second door 20.

The first door 15 and the second door 20 are movable between an open and a closed position. The double wing door 10 is in a closed position when the first door 15 and the second door 20 are in a closed position. The double wing door 10 is in an open position when the first door 15 and/or the second door 20 are in an open position.

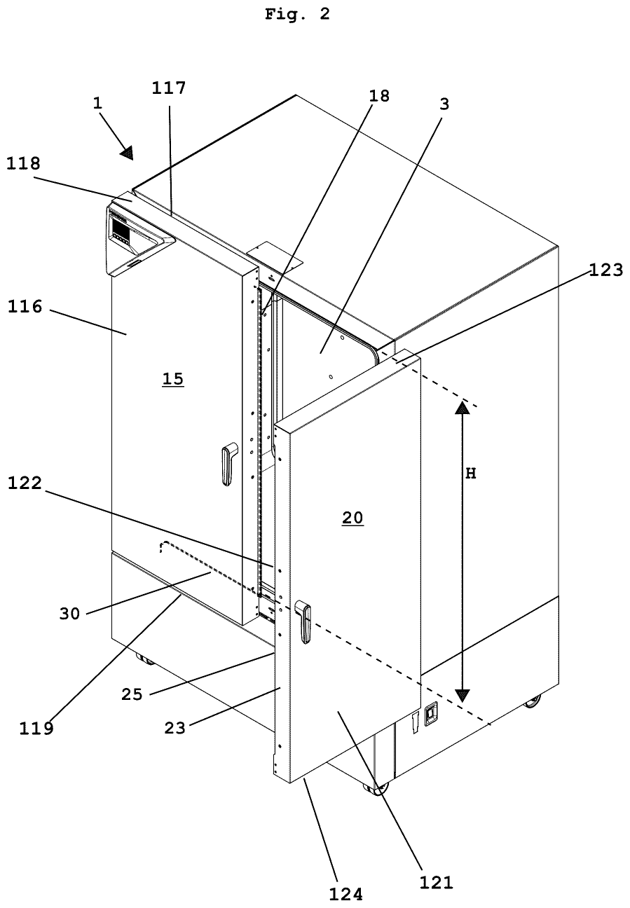

The first door 15 comprises a first front face 116, a first back face 117, a first lateral face 17, a first front side 16 as well as a first surface 118 and a first lower surface 119. The first lateral face 17 and the first front side 16, the first surface 118 and the first lower surface 119 as well as the first front face 116 and the first back face 117 can each be disposed such that they are opposite each other (cf. FIG. 2). The first door 15 can comprise an outer body 14 and an interior region 13 filled with foam.

The second door 20 comprises a second front face 121, a second back face 122, a second lateral face 22, a second front side 21 as well as a second surface 123 and a second lower surface 124. The second lateral face 22 and the second front side 21, the second surface 123 and the second lower surface 124 as well as the second front face 121 and the second lower surface 124 can each be disposed oppositely (cf. FIG. 2). The second door 20 can comprise an outer body 24 and an inner region 26 filled with foam. The outer body 14, 24 of the first door 15 and of the second door 20 is preferably developed of a material having good thermal conductivity, especially preferred of stainless steel. The outer body 14, 24 of the first door 15 and/or of the second door 20 can also be developed of aluminum. The foam with which the interior region 13, 26 of the first door and/or of the second door 20 can be filled is preferably a polyurethane foam. The foam can also be an ethylene propylene diene monomer foam, a silicone foam or a neoprene foam.

The first door 15 can be rotatably supported on the first lateral face 17 across two hinges 50 on the housing 2 of climate chamber 1. The second door 20 can be rotatably supported on the second lateral face 22 across two hinges 50 on the housing 2 of the climate chamber 1.

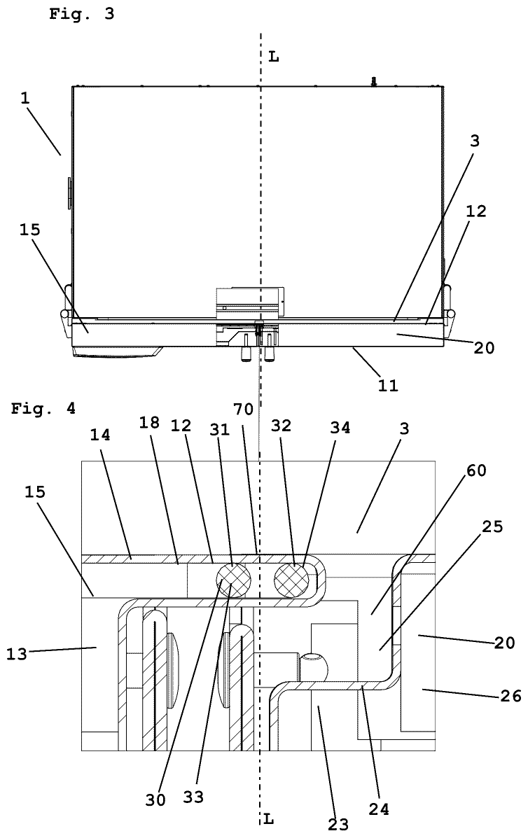

In the closed position the first front side 16 of the first door 15 and the second front side 21 of the second door 20 are facing one another (cf. FIG. 3).

The first door 15 and the second door 20 in the closed position together span a front face 11 and a back face 12 of the double wing door 10 of climate chamber 1. The front face 11 faces in the direction toward the outer surrounding, whereas the back side 12 faces in the direction toward the interior volume 3 of the housing 2 of the climate chamber 1.

The climate chamber 1 comprises a longitudinal axis L that intersects the front face 11 orthogonally. The longitudinal axis L also intersects the back face 12, wherein the longitudinal axis L also preferably intersects the back face 12 orthogonally. The longitudinal axis L starting from the front face 11 extends in the direction of the back face 12 (cf. FIG. 3).

The first front side 16 of the first door 15 comprises a first ledge 18. The first front side 16 of the first door 15 is therewith developed in stepped form. The first ledge 18 of the first door 15 at least partially also spans the back side 12 of the double wing door 10 of the climate chamber 1. The first ledge 18 of the first door 15 herein points in particular in the direction of the second door 20.

The second door 20 comprises a second ledge 23. The second front side 21 of the second door 20 is therewith developed in stepped form. The second ledge 23 therewith points in particular in the direction of the first door 15.

The first ledge 18 of the first door 15 can extend over nearly the entire height H of the interior volume 3 of the climate chamber 1. The second ledge 23 of the second door 20 is preferably developed complementarily to the first ledge 18 of the first door 15. In the closed position the first ledge 18 of the first door 15 can become fit tightly in a recess 25 formed by the second ledge 23 of the second door 20, wherein between the first door 15 and the second door 20, in particular between the first ledge 18 and the second ledge 23 a gap 60 can be developed.

In the closed position the first ledge 18 can be disposed in the direction of the longitudinal axis L preferably at least partially behind the second ledge 23.

In the direction of the longitudinal axis L the first ledge 18 of the first door 15 can be smaller than the second ledge 23 of the second door 20. In the direction of an imaginary axis extending parallel to the first front face 116 the first ledge 18 of the first door 15 can be developed longer than the second ledge 23 of the second door 20.

Within the first ledge 18 is disposed a heating element 30 represented in dashed lines in FIGS. 1 and 2. The heating element 30 can sectionally extend along the first front side 16 of the first door 15. The heating element 30 extends preferably over the entire height H of the interior volume 3 of housing 2 of the climate chamber 1. The heating element 30 can also substantially extend over the complete first front side 16 of the first door 15.

In a margin region of the interior volume 3 the heating element 30 can have a loop 35 in its course (cf. FIG. 1). Due to the loop 35 the thermally critical region of the first door 15, viz. a corner region 19 disposed between the first front side 16 and the first surface 118 and/or the first lower surface 119, can be better heated.

The heating element 30 is preferably electrically connected to a low voltage direct current source (not visible). The low voltage direct current source can draw its energy from a battery (not visible) or an electric network (not visible). The voltage range of the low voltage direct current source is preferably between 12 V and 60 V. The climate chamber 1 can also draw its energy from an alternating current network. The alternating current network preferably has a voltage value of 230 V. Due to the disposition of the heating element 30 within the first ledge 18 the heating element 30 is not accessible from the outside such that unintentional contact with the heating element 30 is avoided.

The heating element 30 preferably comprises a forward conductor 31 and a return conductor 32, wherein the forward conductor 31 and the return conductor 32 are connected in series. The forward conductor 31 and the return conductor 32 can also be connected in parallel. The forward conductor 31 and the return conductor 32 are electrically connected to the low voltage direct current source (not visible), wherein the forward conductor 31 is disposed closer to a positive terminal and the return conductor 32 closer to a negative terminal of the low voltage direct current source.

It is also feasible for only the forward conductor 31 to extend within the first ledge 18 of the first door 15 and the return conductor 32 to function as area heater (not visible) of the first door 15 or conversely.

Starting from a low voltage direct current source (not visible), the heating element 30 can extend initially parallel to the first front face 116 of the first door 15 within the first door 15. The heating element 30 can subsequently extend back and forth within the first ledge 18 substantially over the entire length of the first front side 16 of the first door 15 and subsequently be enabled to lead parallel to the first front face 116 of the first door 15 within the first door 15 back again to the low voltage direct current source (cf. FIG. 1). The measured length which the heating element 30 covers within the first ledge 18 can correspond to more than 50 percent, preferably more than 60 percent, especially preferred more than 80 percent of the measured total length of the heating element 30, wherein start and end of the measured total length is in each case the low voltage direct current source.

The heating element 30 can at least sectionally have a meander-shaped course within the first ledge 18 of the first door 15.

The heating element 30 preferably comprises a wire 33 with a silicone sheathing 34. The silicone sheathing 34 must herein be thick enough to provide sufficient insulation between the wire 33 and the electrically conductive outer body 14 of the first door 15, however it must be thin enough so that the heat radiating from the wire 33 into the outer body 14 of the first door 15 and from there can radiate into the gap 60.

The wire 33 is preferably developed of copper or aluminum wherein the wire can be developed of any electrically conductive material. The wire 33 can comprise a single individual strand or it can comprise several individual strands. The several individual strands can be interconnected in parallel or in series. The wire 33 is electrically connected to the low voltage direct current source (not visible).

The heating element 30 is disposed within the first ledge 18 of the first door 15 preferably such that the silicone sheathing 34 of the wire 33 is disposed on the outer body 14 of the first door 15 very close to, preferably directly on, the first door 15. The thermal coupling between heating element 30 and outer body 14 of the first door 15 is thereby greater. The heating element 30 is preferably in contact at two sites on the outer body 14 of the first door 15. The heating element 30 can be in contact on the outer body 14 of the first door 15 at more than two sites. The heating element 30 can be fixed between two lateral faces 70 of the outer body 14 of the first door 15 and be clamped by them.

The heating element 30, preferably the forward conductor 31 and the return conductor 32, are mechanically fixed due to the foam injection of the interior region 13 of the first door 15.

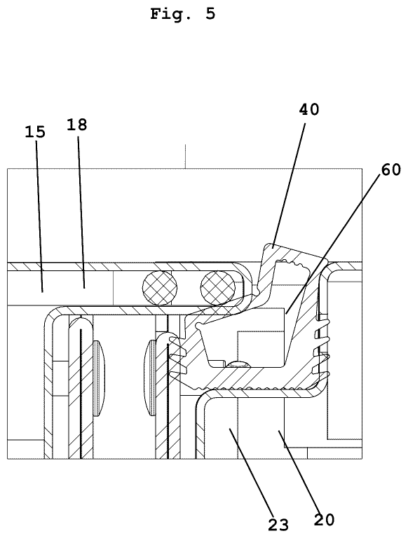

A sealing element 40 can be disposed in the closed position between the first door 15 and the second door 20, wherein in FIG. 5 the sealing element 40, despite the closed door, is depicted under stressed condition.

The sealing element 40 can be developed of an elastic material, preferably of an elastomer or of silicone.

The sealing element 40 can be mechanically fixed on the first door 15 or on the second door 20. A sealing element 40 can also be mechanically fixed with the first door 15 and a further sealing element 40 with the second door 20. In the closed position the sealing element 40 can become deformed such that it can be disposed to fit accurately within the gap 60.

The first ledge 18 of the first door 15 and the second ledge 23 of the second door 20 preferably comprise rounded-off edges in order not to damage the sealing element 40 when closing the double wing door 10.

A second heating element (not shown) can be disposed within the second ledge 23. The second heating element can in particular comprise the technical features described in conjunction with the heating element 30, and can be disposed in the second ledge 23 analogously to the disposition of the heating element 30 in the first ledge 18 of the first door 15.

### LIST OF REFERENCE SYMBOLS

1 Climate chamber
2 Housing
3 Interior volume
4 Bottom (interior volume)
8 Upper edge
9 Lower edge
10 Double wing door
11 Front face
12 Back face
13 Interior region
14 Outer body (first door)
15 First door
16 First front side
17 First lateral face
18 First ledge
19 Corner region
20 Second door
21 Second front side
22 Second lateral face
23 Second ledge
24 Outer body (second door)
25 Recess
26 Interior region
30 Heating element
31 Forward conductor
32 Return conductor
33 Wire
34 Silicone sheathing
35 Loop
40 Sealing element
50 Hinge
60 Gap
70 Lateral faces
116 First front face
117 First back face
118 First surface
119 First lower surface
121 Second front face
122 Second back face
123 Second surface
124 Second lower surface
L Longitudinal axis
H Height (interior volume)

We claim:

1. A climate chamber comprising:
a double wing door movable between an opened and a closed position, the double wing door comprising a first door and a second door,
the first door comprising a first front side with a first ledge and the second door comprising a second front side with a second ledge,
wherein the first front side and the second front side are substantially facing one another in the closed position, and
a heating element disposed within the first ledge of the first door.

2. The climate chamber of claim 1, wherein the first ledge extends substantially over an entire length of the first front side and the second ledge extends substantially over an entire length of the second front side.

3. The climate chamber of claim 1, wherein the heating element extends substantially over an entire length of the first ledge.

4. The climate chamber of claim 1, wherein the double wing door comprises a front face and a back face, and the first ledge extends in a direction of a longitudinal axis that orthogonally intersects the front face and extends from the front face toward the back face, the first ledge being at least partially disposed behind the second ledge.

5. The climate chamber of claim 4, wherein the heating element is at least partially disposed behind the second ledge in the direction of the longitudinal axis.

6. The climate chamber of claim 1, further comprising a sealing element disposed between the first ledge and the second ledge in the closed position.

7. The climate chamber of claim 1, wherein the heating element comprises a forward conductor and a return conductor, the forward conductor and the return conductor being substantially disposed within the first ledge.

8. The climate chamber of claim 1, wherein the heating element has a loop-form course in at least one corner region of the first door.

9. The climate chamber of claim 1, wherein the heating element comprises an electrically conductive wire with a silicone sheathing.

10. The climate chamber of claim 1, wherein the heating element is electrically connected to a low voltage direct current source.

11. The climate chamber of claim 1, wherein the first door and the second door each comprise an outer body having good thermal conductivity, and the outer body is injected with a foam having good insulation properties.

12. The climate chamber of claim 11, wherein the heating element is fixed by the foam within the first ledge.

13. The climate chamber of claim 11, wherein the heating element contacts the outer body of the first door at least at one site.

14. The climate chamber of claim 1, further comprising an area heating thermally coupled with at least one of the first door and the second door.

15. The climate chamber of claim 1, further comprising a second heating element disposed within the second ledge.

16. A climate chamber, comprising:
a housing defining an interior volume,
a double wing door movable between an opened and a closed position for accessing the interior volume, the double wing door comprising a first door and a second door,
the first door comprising a first front side with a first ledge projecting therefrom, and the second door comprising a second front side with a second ledge projecting therefrom,
wherein the first front side and the second front side face one another in the closed position, and the first ledge and the second ledge form a sealing interface between the first door and the second door in the closed position,
a heating element disposed within the first ledge,
wherein the heating element extends substantially over a length of the first ledge to prevent icing and condensation at the sealing interface.

17. The climate chamber of claim 16, wherein the double wing door comprises a front face and a back face,
wherein the first ledge extends in a direction of a longitudinal axis that orthogonally intersects the front face, with the first ledge being at least partially disposed behind the second ledge in the closed position, and
wherein the heating element comprises a forward conductor and a return conductor, wherein the forward conductor and the return conductor are substantially disposed within the first ledge.
